(19) United States
(12) Patent Application Publication
(10) Pub. No.: US 2009/0092785 A1
(43) Pub. Date: Apr. 9, 2009

(54) Method for Producing a Composite Material with Low Density and High Toughness

(75) Inventor: Pietro Vallorani, Castel Di Lama (IT)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Captone Enterprise LLC, Wilmington, DE (US)

(21) Appl. No.: 11/996,405

(22) PCT Filed: Jul. 22, 2005
(86) PCT No.: PCT/IT05/00434

§ 371 Date: Nov. 12, 2008

(51) Int. Cl. B32B 5/12; B32B 37/00; B28B 19/00; B32B 27/38

(52) U.S. Cl. 428/113; 156/280; 428/413; 156/390

(57) ABSTRACT

A method for producing a composite material comprising at least one cold bonding phase of a plastic material with a prepreg material, and a subsequent phase of heating the semifinished product obtained to a temperature close to the glass transition temperature of the plastic material and able to induce the cross-linking of the impregnating resin present in the prepreg material.

### TECHNICAL FIELD

The present invention concerns a method for producing a composite material with low density and high toughness.

Here and below, the term PREPREG material is used to define a type of material made of fibres impregnated with crosslinkable resin.

### BACKGROUND ART

For a long time the need has been felt to have resistant materials that at the same time present a low weight. This need, as may seem obvious, is particularly felt in the industry of transport vehicles, sports equipment and the exploitation of wind energy.

To respond to this need composite materials have been produced which, coming from the union of different materials, embody their different characteristics.

Although the materials produced present the characteristics sought, they nevertheless have the disadvantage of not being structured like a single material, with the problem that the two starting materials are not efficaciously bonded.

### DISCLOSURE OF INVENTION

The aim of the present invention is to produce, in a simple and economic way, a method for producing composite materials with low density and high toughness which do not present the problems of the prior art.

The object of this invention is a method for producing a composite material characterised by comprising at least one bonding phase of a plastic material having a glass transition temperature Tg with a prepreg material, and a subsequent curing phase in which a semifinished product obtained from said bonding phase is subjected to a curing temperature Tc; said curing temperature Tc presenting a ΔT difference less than or equal to 10° C. with respect to said glass transition temperature Tg and being suited to induce the cross-linking of an impregnating resin present in said prepreg material.

Preferably, the curing temperature Tc presents a ΔT difference less than or equal to 5° C. with respect to said glass transition temperature Tg.

Preferably, the curing temperature Tc presents a ΔT difference less than or equal to 10° C. with respect to a cross-linking temperature Tr of the impregnating resin present in the prepreg material.

Preferably, the curing temperature Tc presents a ΔT difference less than or equal to 5° C. with respect to the cross-linking temperature Tr of the impregnating resin present in the prepreg material.

Preferably, the glass transition temperature Tg of the plastic material presents a ΔT difference less than or equal to 5° C. with respect to the cross-linking temperature Tr.

Even more preferably, the glass transition temperature Tg substantially coincides with the cross-linking temperature Tr.

By cross-linking temperature is meant the temperature at which the viscosity of the resin decreases just before the resin itself hardens following the cross-linking reactions.

Preferably, the curing temperature Tc is in the range between 80 and 180° C.

Preferably, the plastic material is composed of a polyurethane resin.

Preferably, the prepreg material has an epoxy matrix, and more preferably it is composed of carbon fibre impregnated with epoxy resin.

Preferably, the bonding phase is realised cold.

Preferably, the method to which the present invention refers comprises a surface treatment phase after the curing phase, and in which said impregnating resin is applied on the surface of the composite material obtained from the curing phase and subsequently polymerised.

Preferably, the surface treatment comprises a final operation in which an acrylic paint is applied on an external surface of the composite material obtained after the curing operation.

A further object of the present invention concerns a mould for producing composite material and comprising two reinforcements suited to be bonded together; said mould being characterised in that each of the two reinforcements comprises a portion of insulating material, two portions of conducting material located on opposite sides with respect to said insulating portion and at least one conductivity element housed in said portion of insulating material and suited to connect the two portions of conducting material.

### BRIEF DESCRIPTION OF THE DRAWINGS

The following example is given for the purpose of illustration without limitation, for a better understanding of the invention with the aid of the figure in the enclosed drawing, in which:

FIG. 1 is a cross section of a preferred embodiment of the mould for producing composite materials according to the present invention; and

FIG. 2 is a cross section of a composite material obtained according to the method of the present invention.

### BEST MODE FOR CARRYING OUT THE INVENTION

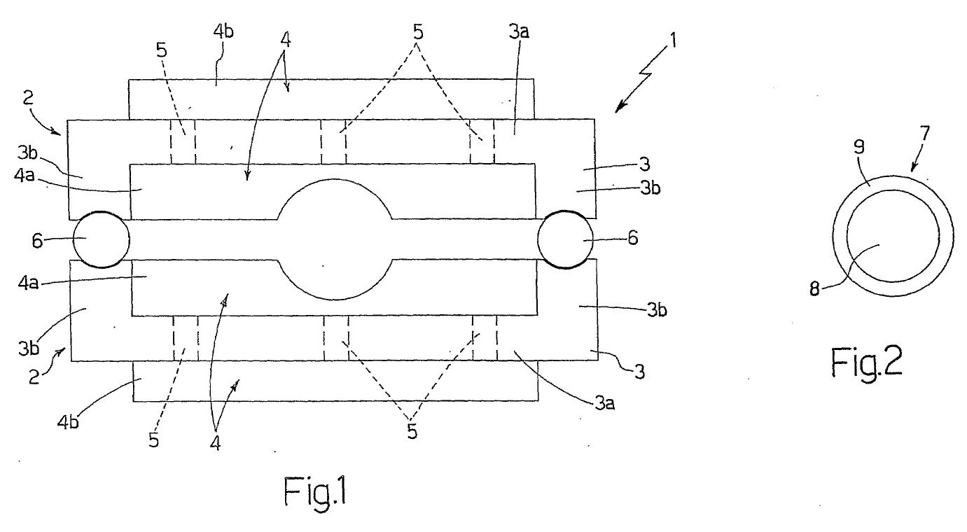

In FIG. 1 the mould to which the present invention refers is indicated altogether with 1. The mould 1 comprises two reinforcements 2 between which the composite material is produced.

Each of the reinforcements 2 comprises a sheet of insulating material 3, two sheets of conducting material 4 located on opposite sides with respect to the sheet of insulating material 3, and three conductivity elements 5 each of which is housed inside the sheet of insulating material 3 and is in contact with both the sheets of conducting material 4.

The sheet of insulating material 3 may be realised, for example, in glass fibre, in rock wool, in polyurethane foam or in sheets of thermal paper, while the sheets of conducting material 4 may be realised for example, in metal or in metallic resin.

In particulars, the sheets of conducting material 4 are subdivided into an internal sheet 4a which is to be in contact with the composite material, and an external sheet 4b.

The sheet of insulating material 3 comprises a central portion 3a and two side portions 3b extending at a right angle to the central portion 3a. The sheet of insulating material 3 made in this way covers the internal sheet 4a of conducting material both on the top and at the side. In this way, heat loss by irradiation from the sheet of conducting material 4a, which is responsible for the transmission of heat to the composite material, is limited.

As illustrated in FIG. 1, between the two internal sheets 4a of conducting material of the two reinforcements 2 is interposed a fluid-proof insulating layer 6 which may be made of silicone.

### Example of a Composite Material

In FIG. 2 is illustrated a composite material 7 produced according to the method of the present invention. The composite material 7 presents a cylindrical conformation and comprises a core portion 8 made of polyurethane foam resin marketed by “TRIAL CHEM SRL” with the code “UP460E” and having a glass transition temperature of 85° C., and a portion of coating 9 composed of three layers of prepreg material marketed by “SEAL SPA” and composed of carbon fibres soaked in an epoxy resin having a cross-linking temperature of 85° C.

In particular, the coating portion is composed of an internal layer with fibre orientation 0/90 degrees with the trade name “TEXIPREG® ET223”, an intermediate layer with fibre orientation 90 degrees with the trade name “UD HS 300”, and an external layer with fibre orientation 0/90 degrees with the trade name “TEXIPREG® ET223”.

The core portion 8 has a radius of 0.5 cm and the coating portion 9 has a thickness of 0.7 mm.

According to the method of the present invention, the two materials have been positioned cold according to the arrangement in FIG. 2 and afterwards, the semifinished product obtained is placed inside the mould in FIG. 1 and heated in an oven to a temperature of 85° C. for a time of 10 hour.

The semifinished product is then heated to a temperature equal both to the glass transition temperature Tg of the polyurethane resin and to the cross-linking temperature Tr of the epoxy resin which impregnates the carbon fibres in the prepreg material that constitutes the coating portion 9.

Once the curing phase at 85° C. is ended, a layer of epoxy resin is applied on the external surface of the coating portion 9. At this point the composite material is again placed inside the mould in FIG. 1 and subjected to a temperature of 85° C. for 3 hours.

Tests have been carried out on the composite material which are able to demonstrate its improved properties.

Table I shows the physical characteristics of the resins taken individually and of the composite material obtained from the same resins according to the method of the present invention.

In particular, the physical characteristics shown concern the density and the compressive and tensile strength according to standard ASTM D412C.

TABLE I

| | | | Tensile |
|---|---|---|---|
| | density | Compressive | strength |
| | (gr/cc) | strength (MPa) | (MPa) |
| Polyurethane | 1.1 | 48.3 | 30 |
| resin | | | |
| Prepreg material | 1.4 | 510 | 530 |
| with epoxy | | | |
| matrix | | | |
| Composite | 1.25 | 600 | 630 |
| material | | | |

As can be seen from the data given in table I, the composite material obtained according to the method of the present invention presents characteristics of lightness and toughness surprisingly better than those of the components taken individually.

The plastic materials preferred for the present invention, besides polyurethane foam, are ABS, PVC and PET.

The prepreg materials preferred for the present invention, besides carbon fibre impregnated with an epoxy resin, are those in which the fibre is included in the group composed of Glass E, Glass S, Aramidic fibres, Alluminia, Graphite, Silicon, Tungsten and Beryllium, and in which the matrix is included in the group composed of Phenolic resin, Polyester, Polycarbonate, Vinylester, Silicon Resin, Urethane resin and Bismaleimide resins.

1. Method for producing a composite material characterised by comprising at least one bonding phase of a plastic material having a glass transition temperature Tg with a prepreg material, and a subsequent curing phase in which a semifinished product obtained from said bonding phase is subjected to a curing temperature Tc; said curing temperature Tc presenting a ΔT difference less than or equal to 10° C. with respect to said glass transition temperature Tg and being suited to induce the cross-linking of an impregnating resin present in said prepreg material.

2. Method according to claim 1, characterised in that said curing temperature Tc presents a ΔT difference less than or equal to 5° C. with respect to said glass transition temperature Tg.

3. Method according to claim 1, characterised in that the curing temperature Tc presents a ΔT difference less than or equal to 10° C. with respect to a cross-linking temperature Tr of the impregnating resin present in the prepreg material.

4. Method according to claim 1, characterised in that said curing temperature Tc is in the range between 80 and 180° C.

5. Method according to claim 4, characterised in that said plastic material is composed of a polyurethane resin.

6. Method according to claim 4, characterised in that said prepreg material has an epoxy matrix.

7. Method according to claim 6, characterised in that said prepreg material is composed of carbon fibre impregnated with an epoxy resin.

8. Method according to claim 1, characterised in that said plastic material is coated with said prepreg material.

9. Method according to claim 1, characterised in that said bonding phase is realised cold.

10. Method according to claim 1, characterised in that it comprises a surface treatment phase after the curing phase, and in which said impregnating resin is applied on the surface of the composite material obtained from the curing phase and subsequently polymerised.

11. Method according to claim 10, characterised in that said surface treatment comprises a final operation in which an acrylic paint is applied on an external surface of the composite material obtained after said curing operation.

12. Composite material characterised in that it is produced with the method according to claim 1.

13. Composite material according to claim 12, characterised in that it comprises an internal portion composed of polyurethane resin and a coating portion composed of a prepreg material comprising carbon fibres impregnated with an epoxy resin.

14. Composite material according to claim 13, characterised in that said coating portion comprises at least two layers of prepreg material, each one of which has an orientation different of the fibres from that presented by the other layer.

15. Composite material according to claim 14, characterised in that said coating portion comprises an internal layer with fibre orientation 0/90 degrees, an intermediate layer with fibre orientation 90 degrees and an external layer with fibre orientation 0/90 degrees.

16. Mould (1) for producing composite material and comprising two reinforcements (2) suited to be bonded together; said mould being characterised in that each of the two reinforcements (2) comprises a portion of insulating material (3), two portions of conducting material (4) located on opposite sides with respect to said insulating portion and at least one conductivity element (5) housed in said portion of insulating material (3) and suited to connect the two portions of conducting material (4).

17. Mould according to claim 16, characterised in that said portion of insulating material (3) comprises a central portion (3a) and two side portions (3b) extending at a right angle to the central portion (3a).

18. Mould according to claim 16 or 17, characterised in that it comprises an insulating material (6) in use inserted in a fluid-proof way between two portions of conducting material (4) of the two respective reinforcements (2).
